(19) United States
(12) Patent Application Publication
(10) Pub. No.: US 2012/0192729 A1
(43) Pub. Date: Aug. 2, 2012

(54) Juice Machine and Filter Thereof

(76) Inventor: Jin Yi Huang, Tainan City (TW)

(21) Appl. No.: 13/351,316

(22) Filed: Jan. 17, 2012

(30) Foreign Application Priority Data
Jan. 28, 2011 (CN) 201110031263.5

(51) Int. Cl. A23N 1/02; B01D 29/00

(52) U.S. Cl. 99/511; 210/498

(57) ABSTRACT

A juice machine includes a cutter module, and the cutter module includes a cutter turntable, a filter, and a cutter flywheel. The filter includes a bottom plate, a first side plate protruded and tilted upwardly from an external periphery of the bottom plate, a filter plate horizontally extended from the top of the first side plate, a tilted second side plate protruded upwardly from an edge of the filter plate, an opening formed at the center of the bottom plate, a plurality of first meshes formed on the first side plate, a plurality of second meshes formed on the filter plate, a plurality of third meshes formed on the second side plate. Therefore, the weight of the filter can be decreased to provide a stable filter and reduce vibrations and noises. The juice machine can enhance both juice squeezing efficiency and juice yield.

### BACKGROUND OF THE INVENTION

1. Field of the Invention

The present invention relates to a filter used in a juice machine and the juice machine using the filter, in particular to the filter and the juice machine capable of improving the juice squeezing efficiency.

2. Description of the Related Art

With reference to FIG. 1 for a conventional juice machine, the conventional juice machine generally includes a filter 12, a cutter flywheel 14 and a lid 16. The filter 12 comprises a bottom plate 122, and a tilted side plate 124 protruded from an external periphery of the bottom plate 122. The cutter flywheel 14 is installed at the bottom of the filter 12. The lid 16 has a feed inlet 162 formed at the center of the lid 16. The lid 16 is covered onto the top of the filter 12. Fruits are put into the juice machine through the feed inlet 162, and crushed by the cutter flywheel 14, and squeezed within the feed inlet 162, the lid 16 and the filter 12 to produce a fruit juice. The juice machine with this structure squeezes juice from a fruit within the feed inlet 162, the lid 16 and the filter 12 only, and the force of squeezing the fruit is relatively weak, so that fruit dregs cannot be fully squeezed. As a result, both juice yield and juice squeezing efficiency are low.

### SUMMARY OF THE INVENTION

In view of the aforementioned drawbacks of the prior art having difficulties of fully squeezing fruit dregs, a poor juice yield and a low juice squeezing efficiency, it is a primary objective of the present invention to provide a juice machine and a filter of the juice machine to overcome the aforementioned drawbacks.

To achieve the foregoing objective, the present invention provides a filter comprising: a bottom plate; a first side plate, protruded and tilted upwardly from the external periphery of the bottom plate; a filter plate, horizontally extended from the top of the first side plate; a second side plate protruded and tilted upwardly from an edge of the filter plate; an opening, formed at the center of the bottom plate; a plurality of first meshes, formed on the first side plate; a plurality of second meshes, formed on the filter plate; and a plurality of third meshes, formed on the second side plate.

Preferably, the bottom plate is in an annular shape, and the opening is in a circular shape.

To achieve the foregoing objective, the present invention provides a juice machine, comprising: a cutter module, further comprising a cutter turntable, a filter, and a cutter flywheel, characterized in that the filter comprises: a bottom plate; a first side plate, protruded and tilted upwardly from the external periphery of the bottom plate; a filter plate, horizontally extended from the top of the first side plate; a second side plate protruded and tilted upwardly from an edge of the filter plate; an opening, formed at the center of the bottom plate; a plurality of first meshes, formed on the first side plate; a plurality of second meshes, formed on the filter plate; and a plurality of third meshes, formed on the second side plate.

Preferably, the cutter turntable is made of plastic, and the filter is made of metal, and the filter and the cutter turntable are formed integrally by injection molding, and filter is installed at the top of the cutter turntable.

Preferably, the juice machine further comprises a lid device, and the lid device further comprises an upper casing, a feeding barrel, and a block member, and the feeding barrel is installed on the upper casing, and the block member is surrounded around an external side of the bottom of the feeding barrel.

Preferably, the block member has a plurality of prominences protruded downwardly from a bottom surface of the block member.

Preferably, the prominences are ribs or saw-teeth, and the prominences are equidistantly distributed from one another.

Preferably, the block member and the plurality of prominences are disposed at the top of the filter plate of the filter, and a gap is formed among the filter plate and the block member and the prominences.

Preferably, the juice machine further comprises a housing, a motor, a middle seat, a clutch module, a lid device, a presser module, and two handles. Wherein, the housing further comprises a base and a main casing, and the main casing is installed at the top of the base; the motor is installed on the base and disposed in the main casing; the middle seat is installed at the top of the main casing for installing the cutter module therein; the clutch module is installed between the main casing and the middle seat; and a cutter flywheel is installed in the filter and driven and rotated by a driving force transmitted from the motor; the presser module comprises a presser and a top cover, and the presser is installed in the feeding barrel, and the cover is installed at a top end of the presser; and the two handles are installed on both sides of the main casing respectively.

The present invention has the following advantages and effects:

1. If fruit dregs are stacked too high during the juice squeezing process, the fruit dregs may be squeezed between the filter and the upper casing. However, the filter of the conventional juice machine is tilted, so that the upper casing and the filter will not be aligned precisely with each other in a vertical direction, and the pressure exerted onto the fruit dregs for squeezing will be less. Therefore, the present invention adds a filter plate in the filter, such that when the fruit dregs are squeezed between the filter plate and the upper casing of a conventional juice machine, the upper casing and the filter plate of the filter are basically aligned with each other in the vertical direction, so that the force for squeezing the fruit dregs will be relatively larger to enhance the juice yield and the juice squeezing efficiency.

2. The present invention further has a plurality of second meshes formed on the filter plate of the filter to decrease the weight of the filter and stabilize the filter in order to reduce vibrations and noises.

3. A conventional juice machine filter generally has a tilted side plate, and the filter of the present invention has two tilted side plates and a horizontal filter plate, and the filter plate has a plurality of second meshes formed thereon, so that the invention increases the quantity of meshes formed on the filter and the area of the meshes to expedite the output of the fruit juice and enhance the juice squeezing efficiency.

4. The present invention adds a filter plate to the filter and a block member to the upper casing, and the block member is disposed at the top of the filter plate, and a gap is formed between the block member and the filter plate, so that when fruit dregs enter into the gap and are squeezed by the block member and the filter plate further to produce fruit juice, and the block member has a plurality of prominences such as ribs or saw-teeth, and these prominences can further increase the squeezing force of the fruit dregs, so that the fruit dregs can be squeezed to a very dry level to improve the juice yield by 8-20% and also enhance the juice squeezing efficiency.

The following table compares the juice yield of various different fruits of the juice machine of the present invention and the conventional juice machine, and the juice yield refers to the ratio of the weight of the produced juice to the weight of the fruit used for making the juice.

| | Juice machine of the | Conventional juice |
|---|---|---|
| | present invention | machine |
| Carrot | 61.2% | 51.4% |
| Apple | 74.6% | 68.2% |
| Watermelon | 82.0% | 74.3% |
| Tomato | 73.9% | 62.6% |
| Cucumber | 75.4% | 68.9% |
| Pear | 72.9% | 66.8% |

In the table above, both juice yield and juice squeezing efficiency of the juice machine of the present invention are obviously higher than those of the conventional juice machine for various different fruits.

### BRIEF DESCRIPTION OF THE DRAWINGS

FIG. 1 is an exploded view of a conventional juice machine including a filter, a cutter flywheel and a lid device;

FIG. 2 is an exploded view of a juice machine in accordance with a first preferred embodiment of the present invention;

FIG. 3 is a schematic view of a filter of a juice machine in accordance with the first preferred embodiment of the present invention;

FIG. 4 is a perspective view of a lid module of a juice machine in accordance with the first preferred embodiment of the present invention;

FIG. 5 is another perspective view of a lid module of a juice machine in accordance with the first preferred embodiment of the present invention;

FIG. 6 is a blow-up view of Section A of FIG. 5;

FIG. 7 is a cross-sectional view of a juice machine installed with a lid module and a filter in accordance with the first preferred embodiment of the present invention;

FIG. 8 is a perspective view of a juice machine in accordance with the first preferred embodiment of the present invention;

FIG. 9 is an exploded view of a juice machine in accordance with a second preferred embodiment of the present invention;

FIG. 10 is a perspective view of a filter of a juice machine in accordance with the second preferred embodiment of the present invention;

FIG. 11 is a perspective view of a lid device of a juice machine in accordance with the second preferred embodiment of the present invention;

FIG. 12 is another perspective view of a lid device of a juice machine in accordance with the second preferred embodiment of the present invention;

FIG. 13 is blow-up view of Section B of FIG. 12;

FIG. 14 is a cross-sectional view of a juice machine installed with a lid module and a filter in accordance with the second preferred embodiment of the present invention; and

FIG. 15 is a perspective view of a juice machine in accordance with the second preferred embodiment of the present invention.

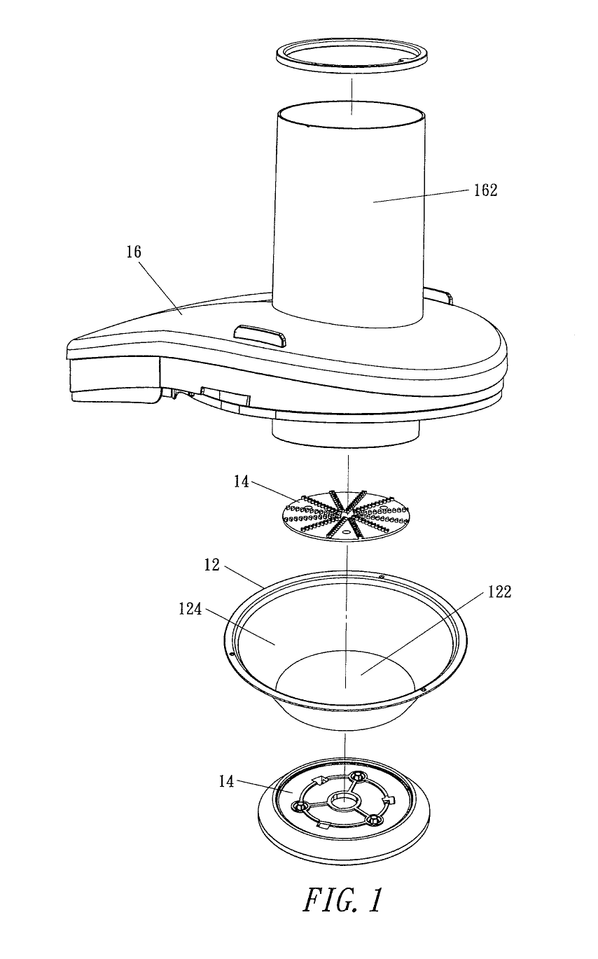

### DETAILED DESCRIPTION OF THE PREFERRED EMBODIMENTS

To make it easier for our examiner to understand the technical characteristics and measures of the present invention to achieve the aforementioned objects and effects, we use preferred embodiments with related drawings for the detailed description of the present invention as follows.

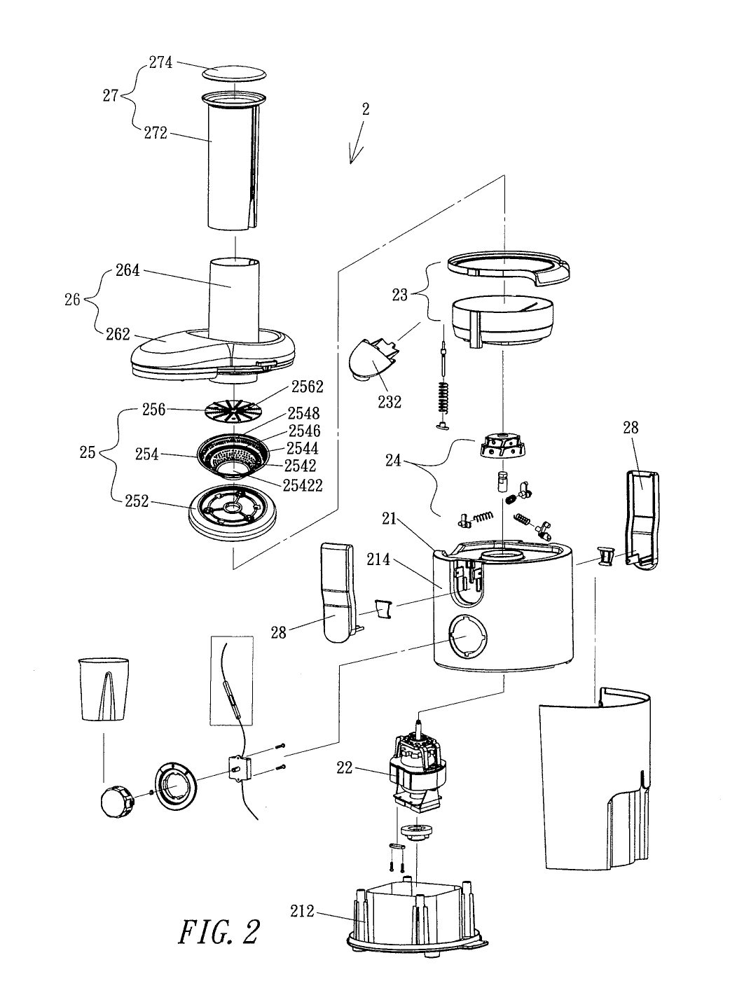

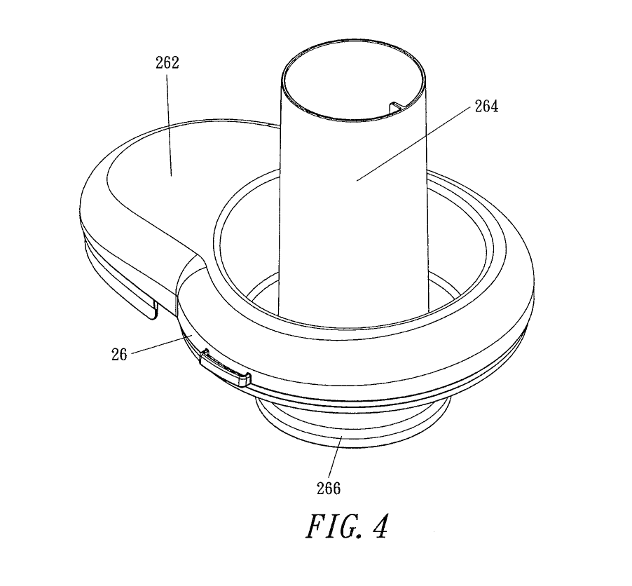

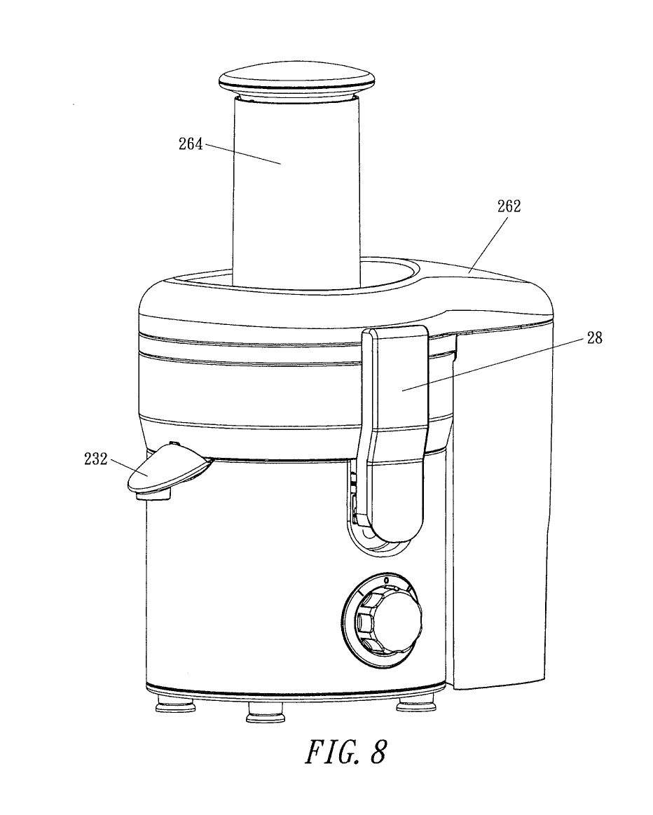

With reference to FIGS. 2 to 8 for a juice machine in accordance with the first preferred embodiment of the present invention, the juice machine 2 comprises a housing 21, a motor 22, a middle seat 23, a clutch module 24, a cutter module 25, a lid module 26, a presser module 27, and two handles 28.

The housing 21 comprises a base 212, and a main casing 214.

The main casing 214 is installed at the top of the base 212.

The motor 22 is installed on the base 212 and disposed in the main casing 214. The motor 22 comes with a plurality of speeds.

The middle seat 23 is installed at the top of the main casing 214. A juice outlet 232 is formed at a front end of the middle seat 23.

The clutch module 24 is installed between the main casing 214 and the middle seat 23.

The cutter module 25 is installed inside the middle seat 23. The cutter module 25 comprises a cutter turntable 252, a filter 254, and a cutter flywheel 256.

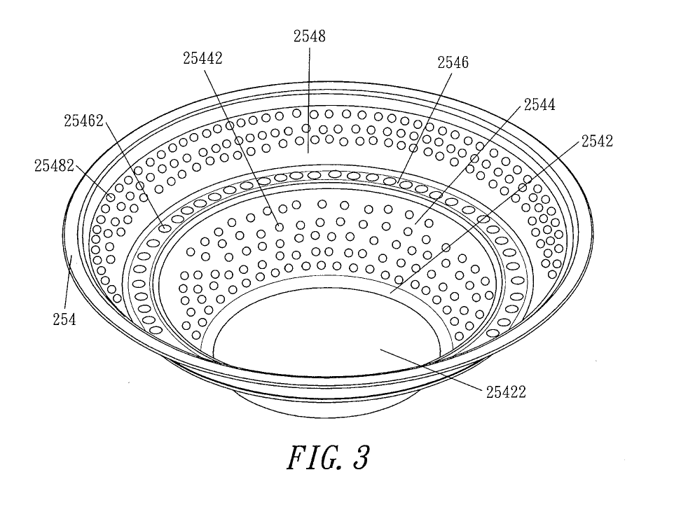

The filter 254 (as shown in FIG. 3) comprises an annular bottom plate 2542, a first side plate 2544 protruded and tilted upwardly from an external periphery of the bottom plate 2542, a filter plate 2546 extended outwardly from the top of the first side plate 2544, and a second side plate 2548 protruded and tilted upwardly from an edge of the filter plate 2546.

The bottom plate 2542 has a circular opening 25422 formed at the center of the bottom plate 2542.

The first side plate 2544 has a plurality of first meshes 25442 formed thereon.

The filter plate 2546 has a plurality of second meshes 25462 formed thereon.

The second side plate 2548 has a plurality of third meshes 25482 formed thereon.

The cutter turntable 252 is made of plastic, and the filter 254 is made of metal, and the filter 254 and the cutter turntable 252 are integrally formed by injection molding, and the filter 254 is installed a the top of the cutter turntable 252.

The cutter flywheel 256 is installed in the filter 254. The driving force transmitted from the motor 22 drives the cutter flywheel 256 to rotate.

The lid module 26 comprises an upper casing 262, a feeding barrel 264, and a block member 266.

The upper casing 262 is installed at the top of the main casing 214.

The feeding barrel 264 is in a cylindrical shape, and the feeding barrel 264 is mounted onto the upper casing 262, and the feeding barrel 264 is hollow inside, and a fruit can be put into the feeding barrel 264 for squeezing juice.

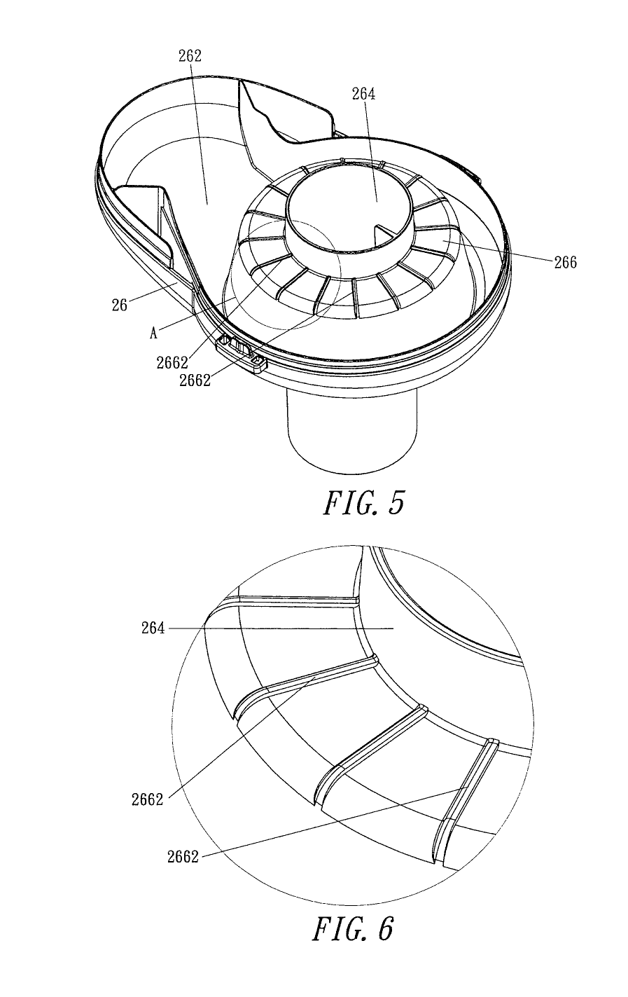

The block member 266 is in a cylindrical shape (as shown in FIG. 5), and the block member 266 is surrounded around an external side of the bottom of the feeding barrel 264.

The block member 266 has a plurality of protruding ribs 2662 protruded on a surface of the bottom of the block member 266 (as shown in FIG. 6). The ribs 2662 are distributed equidistantly from one another.

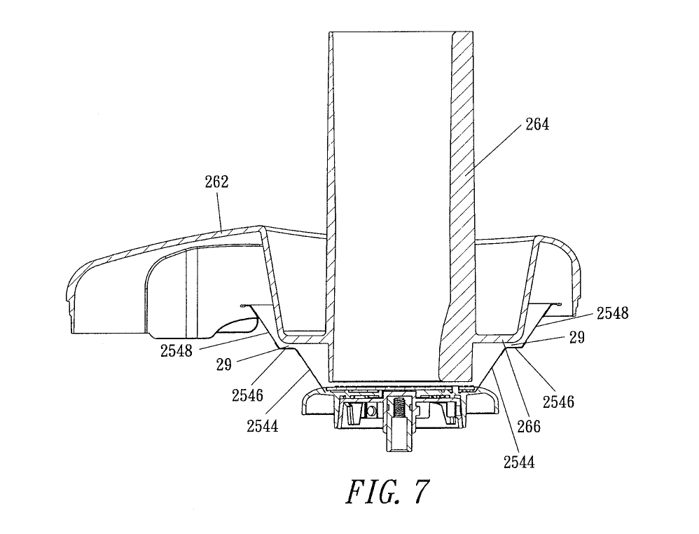

When the upper casing 262 is installed to the top of the filter 254, the block member 266 and the ribs 2662 are disposed above the filter plate 2546 of the filter 254, and a gap 29 exists among the filter plate 2546 and the block member 266 and the rib 2662 (as shown in FIG. 7).

The presser module 27 comprises a presser 272 and a top cover 274.

The presser 272 is installed in the feeding barrel 264.

The top cover 274 is installed at the top of the presser 272.

The two handles 28 are installed on both sides of the main casing 214 respectively.

When use, the two handles 28 are snapped onto the upper casing 262.

When the juice machine 2 is used, fruits are put into the juice machine through the feeding barrel 264, and the cutter flywheel 256 is rotated to crush the fruits, and fruit dregs among the feeding barrel 264, the block member 266, the cutter flywheel 256 and the first side plate 2544 are pressed and squeezed to produce a fruit juice. The cutter flywheel 256 is rotated to push the fruit dregs into the gap 29 between the block member 266 and the filter plate 2546, and the fruit dregs are squeezed by the block member 266 and the filter plate 2546 to further produce fruit juice. The ribs 2662 formed on the block member 266 can increase the pressure exerted onto the fruit dregs to squeeze more fruit juice. The squeezed fruit juice is outputted form the first mesh 25442, the second mesh 25462 and the third mesh 25482.

The first preferred embodiment of the present invention has the following advantages and effects:

1. The present invention adds a filter plate 2546 to the filter 254, such that when the filter 254 of the present invention is applied to a conventional juice machine, the fruit dregs are squeezed between the filter plate 2546 and the upper casing of the conventional juice machine to further squeeze more fruit juice, and the squeezing force of the fruit dregs is increased to enhance both juice yield and juice squeezing efficiency.

2. The filter plate 2546 of the filter 254 of the present invention has a plurality of second meshes 25462 formed thereon to decrease the weight of the filter and stabilize the filter, so as to reduce vibrations and noises.

3. The filter plate 2546 of the filter 254 of the present invention has a plurality of second meshes 25462 formed thereon, and the increased quantity of meshes on the filter increases the area of meshes to expedite the output of the fruit juice, so as to enhance the juice squeezing efficiency.

4. In the present invention, a filter plate 2546 is added to the filter 254, and a block member 266 is added to the upper casing 262, and the block member 266 is disposed at the top of the filter plate 2546, and a gap 29 exists between the block member 266 and the filter plate 2546, so that the fruit dregs entering into the gap 29 can be further squeezed by the block member 266 and the filter plate 2546 to produce squeeze more fruit juice. The block member 266 has ribs 2662 formed thereon, and the ribs 2662 can further increases the squeezing force of the fruit dregs, so that the fruit dregs can be squeezed till they are very dry to enhance both juice yield and juice squeezing efficiency.

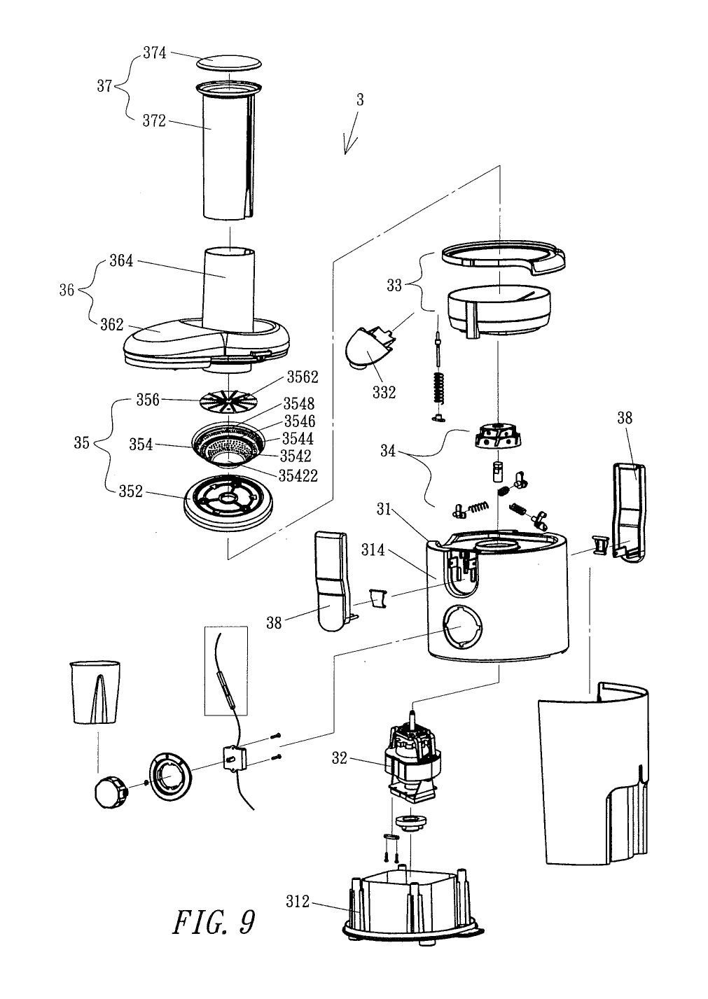

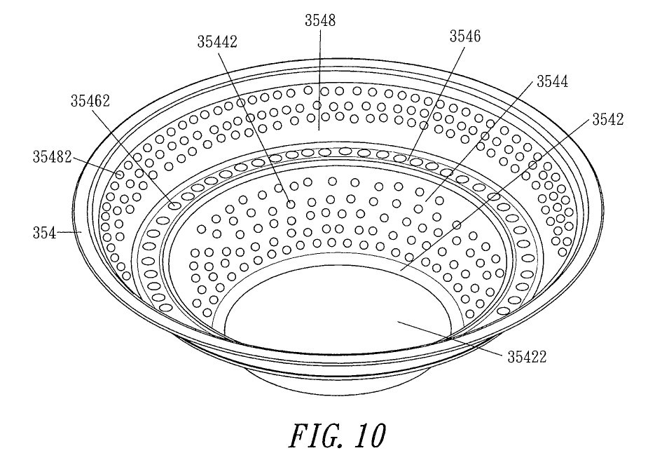

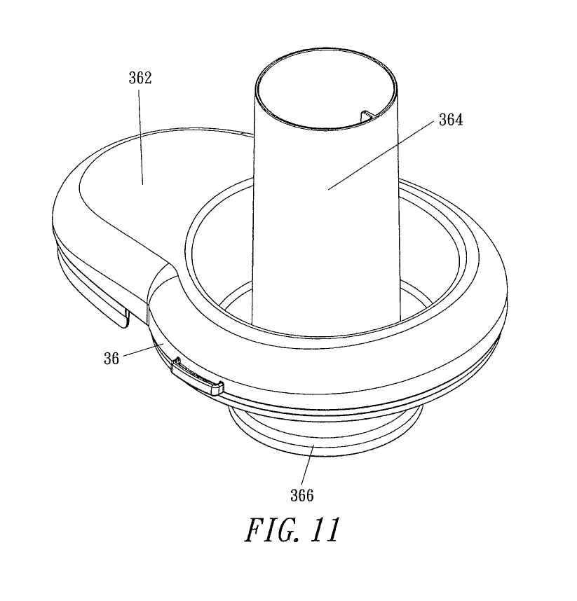

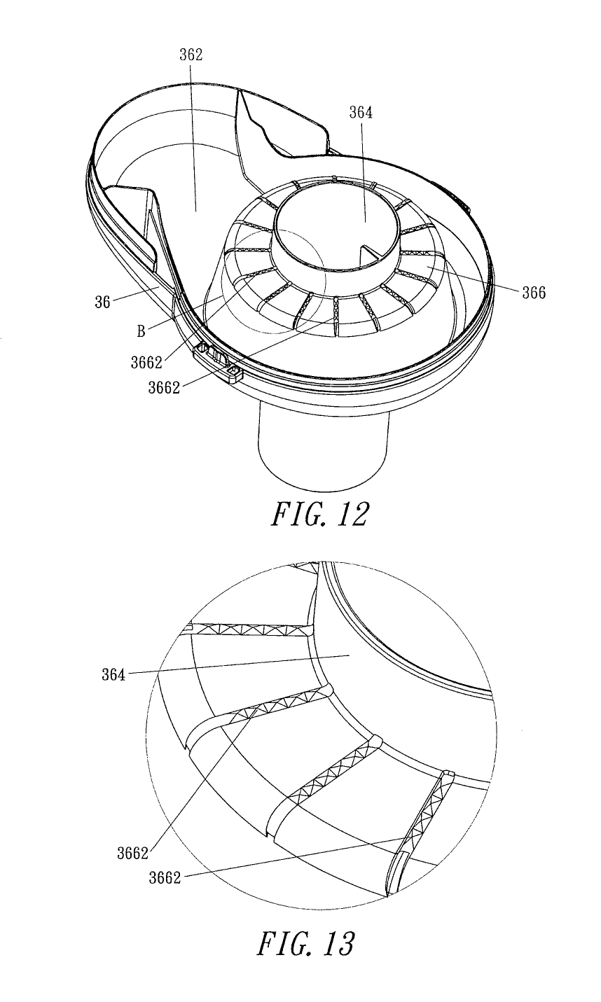

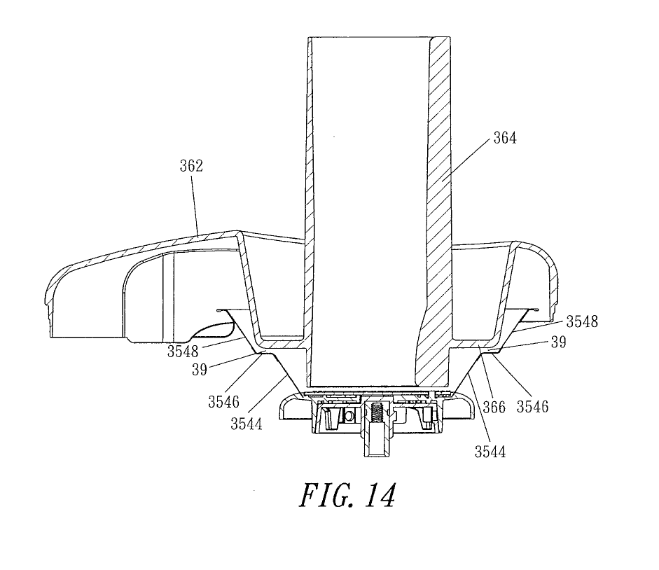

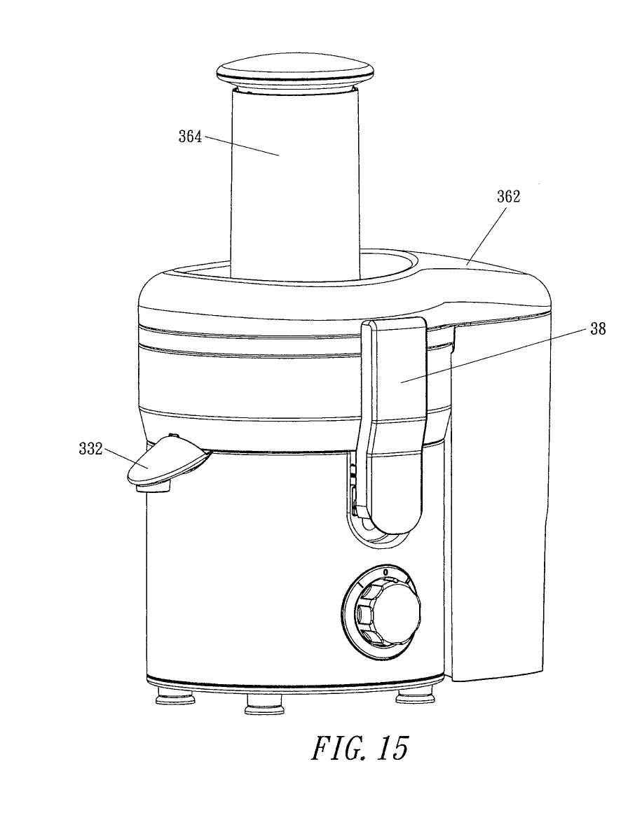

With reference to FIGS. 9 to 15 for a juice machine in accordance with the second preferred embodiment of the present invention, the juice machine 3 comprises a housing 31, a motor 32, a middle seat 33, a clutch module 34, a cutter module 35, a lid module 36, a presser module 37, and two handles 38.

The housing 31 comprises a base 312 and a main casing 314.

The main casing 314 is installed at the top of the base 312.

The motor 32 is installed on the base 312 and disposed in the main casing 314. The motor 32 comes with a plurality of speeds.

The middle seat 33 is installed at the top of the main casing 314. A juice outlet 332 is formed at a front end of the middle seat 33.

The clutch module 34 is installed between the main casing 314 and the middle seat 33.

The cutter module 35 is installed in the middle seat 33. The cutter module 35 includes a cutter turntable 352, a filter 354, and a cutter flywheel 356.

The filter 354 comprises an annular bottom plate 3542, a first side plate 3544 protruded and tilted upwardly from an external periphery of the bottom plate 3542, a filter plate 3546 extended outwardly from the top of the first side plate 3544, and a second side plate 3548 protruded and tilted outwardly form an edge of the filter plate 3546.

The bottom plate 3542 has a circular opening 35422 formed at the center of the bottom plate 3542.

The first side plate 3544 has a plurality of first meshes 35442 formed thereon.

The filter plate 3546 has a plurality of second meshes 35462 formed thereon.

The second side plate 3548 has a plurality of third meshes 35482 formed thereon.

The cutter turntable 352 is made of plastic, and the filter 354 is made of metal, and the filter 354 and the cutter turntable 352 are integrally formed by injection molding, and the filter 354 is installed above the cutter turntable 352.

The cutter flywheel 356 is installed in the filter 354. The driving force transmitted from the motor 32 drives the cutter flywheel 356 to rotate.

The lid module 36 comprises an upper casing 362, a feeding barrel 364, a block member 366.

The upper casing 362 is installed at the top of the main casing 314.

The feeding barrel 364 is in a cylindrical shape, and the feeding barrel 364 is mounted onto the upper casing 362, and the feeding barrel 364 is hollow inside, so that the fruit is put into the juice machine from the feeding barrel 364 for squeezing juice.

The block member 366 is in a cylindrical shape, and the block member 366 is surrounded around an external side of the bottom of the feeding barrel 364.

The block member 366 has a plurality of convex saw-teeth 3662 protruded downwardly from a bottom surface of the block member 366, wherein the saw-teeth 3662 are equidistantly distributed from one another.

When the upper casing 362 is installed onto the top of the filter 354, the block member 366 and the saw-teeth 3662 are disposed at the top of the filter plate 3546 of the filter 354, and a gap 39 exists among the filter plate 3546 and the block member 366 and the saw-teeth 3662.

The presser module 37 comprises a presser 372 and a top cover 374.

The presser 372 is installed in the feeding barrel 364.

The top cover 374 is installed at a top end of the presser 372.

The two handles 38 are installed on both sides of the main casing 314 respectively, such that when use, the two handles 38 are snapped onto the upper casing 362.

When the juice machine 3 is used, fruits are put into the juice machine from the feeding barrel 364, and the cutter flywheel 356 is rotated to crush the fruits, and fruit dregs among the feeding barrel 364, the block member 366, the cutter flywheel 356 and the first side plate 3544 are comprises to squeeze out a fruit juice. The cutter flywheel 356 is rotated to push the fruit dregs into the gap 39 between the block member 366 and the filter plate 3546, and the fruit dregs are squeezed by the block member 366 and the filter plate 3546 to further squeeze out the fruit juice. The saw-teeth 3662 formed on the block member 366 can increase the pressure exerted onto the fruit dregs to squeeze more fruit juice. The squeezed fruit juice is outputted from the first mesh 35442, the second mesh 35462 and the third mesh 35482.

The second preferred embodiment of the present invention has the following advantages and effects:

1. The filter 354 of the present invention adds a filter plate 3546, such that when the filter 354 of the present invention is applied in a conventional juice machine, the fruit dregs are squeezed between the filter plate 3546 and the upper casing of the conventional juice machine to further squeeze out the fruit juice, so as to increase the squeezing force of the fruit dregs and enhance both juice yield and juice squeezing efficiency.

2. The filter plate 3546 of the filter 354 of the present invention has the plurality of second meshes 35462 formed thereon to decrease the weight of the filter and stabilize the filter, so as to reduce vibrations and noises.

3. The filter plate 3546 of the filter 354 of the present invention has the plurality of second meshes 35462, and the increased quantity of meshes formed on the filter 354 can increase the area of the meshes to expedite the output of the fruit juice, so as to enhance the juice squeezing efficiency.

4. In the present invention, the filter plate 3546 is added to the filter 354, and the block member 366 is added to the upper casing 362, and the block member 366 is disposed at the top of the filter plate 3546, and the gap 39 exists between the block member 366 and the filter plate 3546, such that fruit dregs enter into the gap 39, the fruit dregs are squeezed by the block member 366 and the filter plate 3546 to further squeeze out the fruit juice. The block member 366 has a plurality of saw-teeth 3662 formed thereon, and the saw-teeth 3662 can increase the squeezing force of the fruit dregs to squeeze the fruit dregs until they are very dry, so as to enhance both juice yield and juice squeezing efficiency.

1. A filter of a juice machine, comprising;
a bottom plate;
a first side plate, protruded and tilted upwardly from the external periphery of the bottom plate;
a filter plate, horizontally extended from the top of the first side plate;
a second side plate protruded and tilted upwardly from an edge of the filter plate;
an opening, formed at the center of the bottom plate;
a plurality of first meshes, formed on the first side plate;
a plurality of second meshes, formed on the filter plate; and
a plurality of third meshes, formed on the second side plate.

2. The filter of claim 1, wherein the bottom plate is in an annular shape and the opening is in a circular shape.

3. A juice machine, comprising:
a cutter module, further comprising a cutter turntable, a filter, and a cutter flywheel, characterized in that the filter comprises:
a bottom plate;
a first side plate, protruded and tilted upwardly from the external periphery of the bottom plate;
a filter plate, horizontally extended from the top of the first side plate;
a second side plate protruded and tilted upwardly from an edge of the filter plate;
an opening, formed at the center of the bottom plate;
a plurality of first meshes, formed on the first side plate;
a plurality of second meshes, formed on the filter plate; and
a plurality of third meshes, formed on the second side plate.

4. The juice machine of claim 3, wherein the cutter turntable is made of plastic, and the filter is made of metal, and the filter and the cutter turntable are formed integrally by injection molding, and filter is installed at the top of the cutter turntable.

5. The juice machine of claim 3, further comprising a lid device, and the lid device further comprising an upper casing, a feeding barrel, and a block member, and the feeding barrel being installed on the upper casing, and the block member being surrounded around an external side of the bottom of the feeding barrel.

6. The juice machine of claim 5, wherein the block member has a plurality of prominences protruded downwardly from a bottom surface of the block member.

7. The juice machine of claim 6, wherein the prominences are ribs or saw-teeth, and the prominences are equidistantly distributed from one another.

8. The juice machine of claim 6, wherein the block member and the plurality of prominences are disposed at the top of the filter plate of the filter, and a gap is formed among the filter plate and the block member and the prominences.

9. The juice machine of claim 3, further comprising:
a housing, further comprising a base, and a main casing, and the main casing being installed at the top of the base;
a motor, installed on the base, and disposed in the main casing;
a middle seat, installed at the top of the main casing, for installing the cutter module therein;
a clutch module, installed between the main casing and the middle seat;
a lid device;
a cutter flywheel, installed in the filter, and driven and rotated by a driving force transmitted from the motor;
a presser module, comprising a presser, and a top cover, and the presser being installed in the feeding barrel, and the cover being installed at a top end of the presser; and
two handles installed on both sides of the main casing respectively.

10. The juice machine of claim 5, wherein the block member and the plurality of prominences are disposed at the top of the filter plate of the filter, and a gap is formed among the filter plate and the block member and the prominences.
